(19) United States
(12) Patent Application Publication
(10) Pub. No.: US 2018/0301246 A1
(43) Pub. Date: Oct. 18, 2018

(54) WIRING MEMBER AND METHOD OF MANUFACTURING WIRING MEMBER

(71) Applicant: YAZAKI CORPORATION, Tokyo (JP)

(72) Inventors: Masahiro Ito, Shizuoka (JP); Yuta Kawamura, Shizuoka (JP); Sadaharu Okuda, Shizuoka (JP)

(21) Appl. No.: 15/920,032

(22) Filed: Mar. 13, 2018

(30) Foreign Application Priority Data
Apr. 17, 2017 (JP) 2017-081491

(51) Int. Cl. H01B 9/00; H01B 7/02; H01B 7/08; B60R 16/02

(52) U.S. Cl. CPC H01B 9/006; H01B 7/0275; B60Y 2410/115; H01B 7/0853; B60R 16/0215; H01B 7/0823

(57) ABSTRACT

A wiring member includes conduction paths. Each of the conduction paths includes a conductive portion which extends in a longitudinal direction of each of the conduction paths, and a connection portion which is provided on at least one end of the conductive portion in the longitudinal direction and is configured to be connected to a mating conductor. The conduction paths are disposed in parallel to each other in a width direction of each of the conduction paths perpendicular to the longitudinal direction so that an insulator is arranged between adjacent conductive portions of the conduction paths. The conductive portion of the each of the conduction paths has a layer-stacked structure in which a conductive plate member is folded and overlapped at least one time along a vertical folding line extending in the longitudinal direction.

### CROSS REFERENCE TO RELATED APPLICATIONS

This application is based on Japanese Patent Application (No. 2017-081491) filed on Apr. 17, 2017, the contents of which are incorporated herein by reference.

### BACKGROUND OF THE INVENTION

### 1. Field of the Invention

The present invention relates to a wiring member with which a plurality of conduction paths are capable of being disposed in parallel, and a method of manufacturing the wiring member.

### 2. Description of the Related Art

In the related art, there is known a longitudinal wiring member which is wired in a vehicle to transfer power. As an example of such a wiring member, there is a longitudinal main-line wiring member which is wired along a front and rear direction of a vehicle with a battery mounted on a rear side thereof in order to supply power from the battery on the rear side to an electric equipment on a front side.

As a wiring member (hereinafter, referred to as “wiring member of the related art”) suitable for such a main-line wiring member, there is a wiring member in which a plurality of flat-cable single wires are disposed in parallel in a width direction, the flat-cable single wire being formed such that a conductor of a flat shape extending in the width direction in cross section is coated with an insulator (for example, see JP-A-2011-134667).

In the wiring member in the related art, the conductor of each flat-cable single wire has a flat shape which is thin in a height direction. Therefore, the wiring member in the related art is highly rigid against deformation in the width direction but, on the other hand, extremely less rigid against deformation in the height direction. Therefore, the wiring member in the related art is not suitable to be used under a situation where rigidity in both the width and height directions is required.

### SUMMARY OF THE INVENTION

The invention has been made in view of the circumstance, and an object thereof is to provide a wiring member and a method of manufacturing the wiring member which is suitable to be used under a situation where rigidity in both the width and height directions is required.

In order to achieve the above object, the wiring member according to the invention has the following configurations (1) to (4).

(1) A wiring member including:

a conduction path including:
a conductive portion which extends in a longitudinal direction of the conduction path: and
a connection portion which is provided on at least one end of the conductive portion in the longitudinal direction and is configured to be connected to a mating conductor,

wherein the conductive portion has a layer-stacked structure in which a conductive plate member is folded and overlapped at least one time along a vertical folding line extending in the longitudinal direction.

(2) A wiring member including:

a plurality of conduction paths each including:
a conductive portion which extends in a longitudinal direction of each of the plurality of conduction paths; and
a connection portion which is provided on at least one end of the conductive portion in the longitudinal direction and is configured to be connected to a mating conductor,

wherein the plurality of conduction paths are disposed in parallel to each other in a width direction of each of the plurality of conduction paths perpendicular to the longitudinal direction so that an insulator is arranged between adjacent conductive portions of the plurality of conduction paths; and

wherein the conductive portion of the each of the plurality of conduction paths has a layer-stacked structure in which a conductive plate member is folded and overlapped at least one time along a vertical folding line extending in the longitudinal direction.

(3) The wiring member according to the configuration (2), wherein the connection portions of the plurality of conduction paths have the same positions in a height direction which is perpendicular to both of the longitudinal direction and the width direction.
(4) The wiring member according to the configuration (2) or the configuration (3), wherein each of insulators which are the same in number as the conductive portions of the plurality of conduction paths covers an outer periphery of corresponding one of the conductive portions; and

wherein the plurality of conduction paths are disposed in parallel in the width direction so that the insulators respectively covering the adjacent conductive portions come into contact with each other.

According to the wiring member of the configuration (1), the conductive portion has the layer-stacked structure in which the conductive plate member is folded and overlapped. Therefore, it is possible to obtain a wiring member having a high rigidity with respect to the width direction and the height direction (a direction perpendicular to the longitudinal direction and the width direction). Such conductive portions can be disposed in parallel in the width direction.

According to the wiring member of the configuration (2), each conductive portion has the layer-stacked structure in which the conductive plate member is folded and overlapped. Therefore, each conductive portion has a high rigidity with respect to the width direction and the height direction (a direction perpendicular to the longitudinal direction and the width direction). Accordingly, the wiring member obtained by disposing the conductive portions in parallel in the width direction is suitably used under a situation where rigidity in both the width and height directions is required.

According to the wiring member of the configuration (3), the positions of the plurality of connection portions in the height direction are all the same. Therefore, flexibility in space is improved when the plurality of connection portions are connected to a plurality of mating conductors in a one-to-one manner compared to a case where the positions of the plurality of connection portions in the height direction are different.

According to the wiring member of the configuration (4), the outer periphery of the conductive portion is covered with the insulator to individually complete each of the conduction paths, and the completed conduction paths are disposed in parallel in the width direction to complete the wiring member of this configuration. Therefore, the wiring member is manufactured with ease.

In order to achieve the above object, the method of manufacturing the wiring member according to the invention has the following configurations (5) and (6).

(5) A method of manufacturing a wiring member which includes a plurality of conduction paths each including a conductive portion extending in a longitudinal direction of each of the plurality of conduction paths and a connection portion provided on at least one end of the conductive portion in the longitudinal direction and is configured to be connected to a mating conductor, the plurality of conduction paths being disposed in parallel to each other in a width direction of each of the plurality of conduction paths perpendicular to the longitudinal direction so that an insulator is arranged between adjacent conductive portions of the plurality of conduction paths, the method including:

folding and overlapping a conductive plate member at least one time along a vertical folding line extending in the longitudinal direction to form one of the conduction paths having the conductive portion of a layer-stacked structure and the connection portion which are integrally and continuously formed to each other; and

disposing the plurality of formed conduction paths in parallel in the width direction so that the insulator is arranged between adjacent conductive portions of the plurality of conduction paths.

(6) The method according to the process (5), wherein the conductive plate member is a singular conductive sheet.

According to the process (5) or (6), each conductive portion has the layer-stacked structure by folding and overlapping the conductive plate member. Therefore, each conductive portion has a high rigidity with respect to the width direction and the height direction (a direction perpendicular to the longitudinal direction and the width direction). Accordingly, the wiring member obtained by disposing the conductive portions in parallel in the width direction is suitably used under a situation where rigidity in both the width and height directions is required.

According to the invention, it is possible to provide a wiring member which is suitable to be used under a situation where rigidity in both the width and height directions is required.

Hereinbefore, the invention has been described simply. Further, the details of the invention will become apparent from the description of modes (hereinafter, referred to as “embodiments”) for carrying out the invention with reference to the accompanying drawings.

### BRIEF DESCRIPTION OF THE DRAWINGS

FIG. 1 is a perspective view illustrating a wired state of a wiring member according to an embodiment of the invention in a case where the wiring member is mounted in a vehicle;

FIG. 2 is a perspective view of the wiring member illustrated in FIG. 1;

FIG. 3 is a top view of the wiring member illustrated in FIG. 1;

FIG. 4 is a top view of a metal plate member which is folded to form the wiring member illustrated in FIG. 1;

FIG. 5 is a perspective view of a wiring member according to a modification of the embodiment of the invention;

FIG. 6 is a perspective view of a wiring member according to a first modification of the embodiment of the invention;

FIG. 7 is a perspective view of a wiring member according to a second modification of the embodiment of the invention; and

FIG. 8 is a perspective view of a wiring member according to a third modification of the embodiment of the invention.

### DETAILED DESCRIPTION OF THE EXEMPLARY EMBODIMENTS

Specific embodiments of the invention will be described below with reference to the drawings.

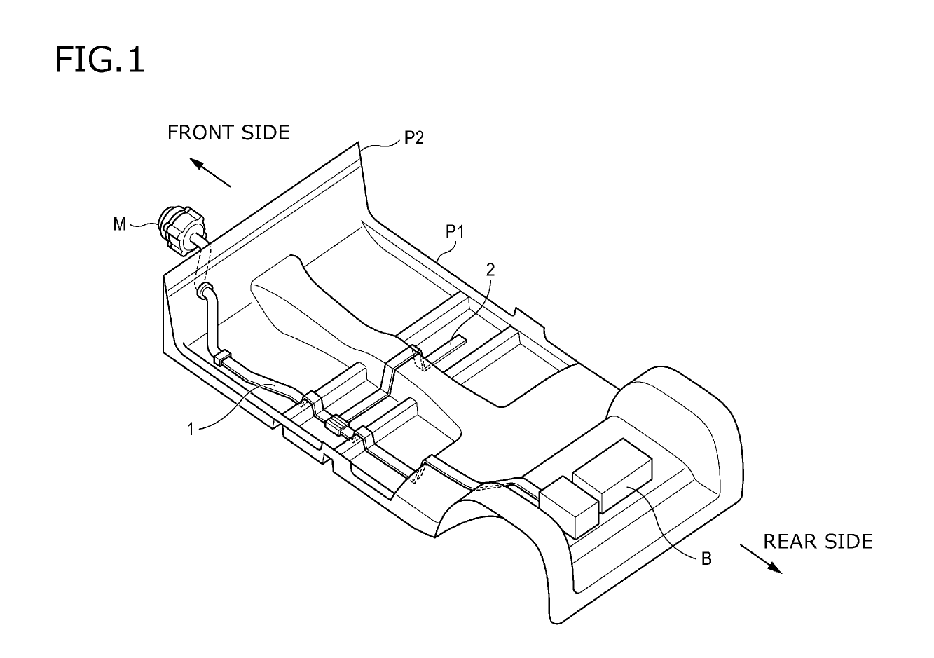

A wiring member 1 according to the embodiment of the invention is mounted in a vehicle in which a battery B is mounted on the rear side as illustrated in FIG. 1 for example. In the example illustrated in FIG. 1, the longitudinal wiring member 1 is wired along a front and rear direction of the vehicle in the upper surface of a floor panel P1 of the vehicle. The rear end of the wiring member 1 is connected to the battery B on the rear side, and the front end passes through a through hole provided in a dash panel P2 to be connected to an electric equipment M positioned in an engine room. Another wiring member 2 is branched from the middle of the wiring member 1. The other wiring member 2 is wired in the right and left direction of the vehicle in the upper surface of the floor panel P1, and the leading end is connected to the other electric equipment (not illustrated). The length of the wiring member 1 is longer than that of the other wiring member 2.

The wiring member 1 is used as a main power line to supply power to the electric equipment M and the other electric equipment. The wiring member 2 is used as a branch power line to supply power only to the other electric equipment. In this way, the wiring member 1 extends in the upper surface of the floor panel P1 along the front and rear direction of the vehicle, and thus is called a main-line wiring member or a backbone.

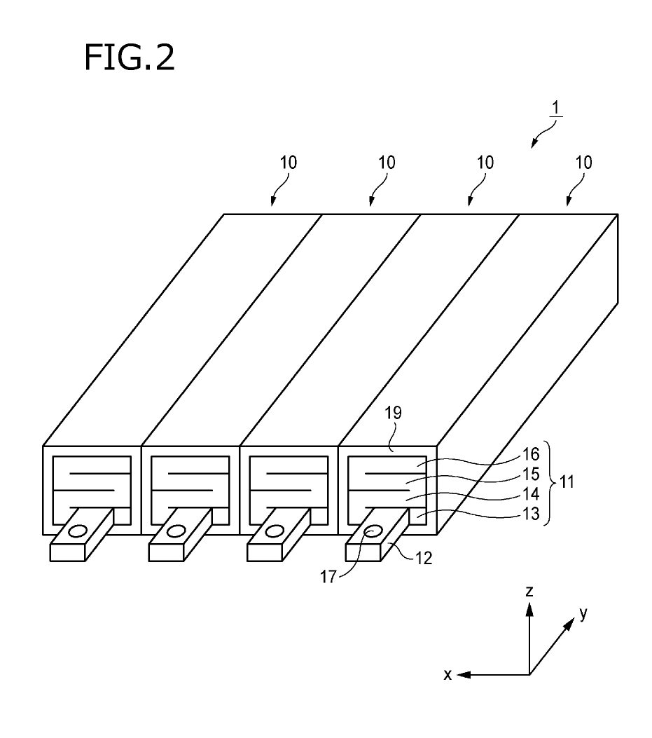

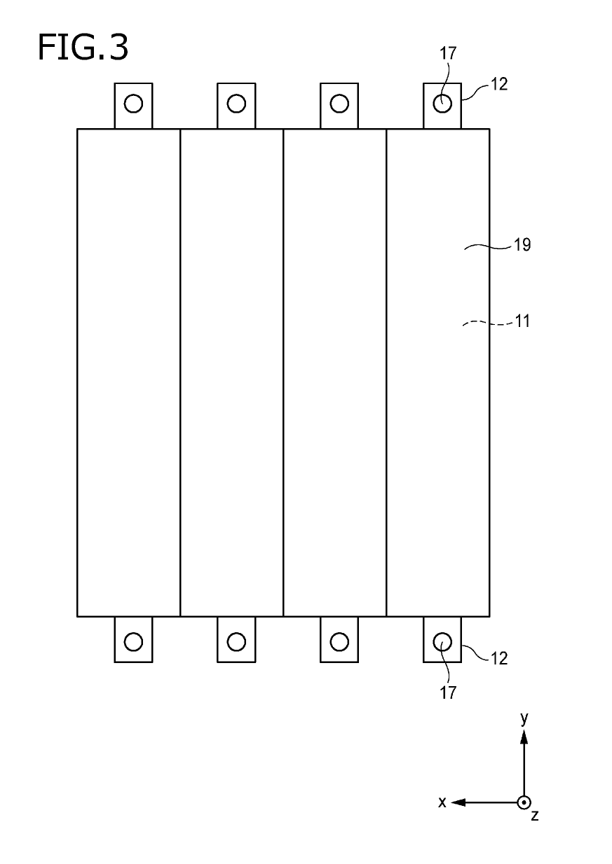

Hereinafter, a configuration of the wiring member 1 according to the embodiment of the invention will be described with reference to FIGS. 2 to 4. For the convenience of explanation, as illustrated in FIG. 2, the x axis (width direction), the y axis (longitudinal direction), and the z axis (height direction) are defined. The “width direction”, the “longitudinal direction”, and the “height direction” are perpendicular to each other. In FIG. 2 (FIGS. 3 to 7 are also the same), on account of space, the drawing may be drawn on a compressed scale in the longitudinal direction. In an actual wiring member 1, a dimension in the longitudinal direction is significantly larger than that in the width direction unlike the drawing.

As illustrated in FIGS. 2 and 3, the longitudinal wiring member 1 extending in the longitudinal direction includes a plurality (four in this example) of conduction paths 10 which are integrally disposed in parallel in the width direction and extend in the longitudinal direction. Each conduction path 10 includes a metal conductive portion 11 which extends in the longitudinal direction and a pair of metal connection portions 12 which are provided at both ends in the longitudinal direction in the conductive portion 11.

In this example, the conductive portion 11 has a layer-stacked structure of a rectangular shape in cross-sectional view which is configured by four layers such as a first layer 13, a second layer 14, a third layer 15, and a fourth layer 16. In this example, each connection portion 12 is a plate portion of a rectangular shape protruding from the end of the conductive portion 11 in the longitudinal direction toward the outside in the longitudinal direction. The connection portion 12 protrudes from the first layer 13 in every conduction path 10. Therefore, the positions of the connection portions 12 in the height direction are all the same.

Each connection portion 12 is provided with a through hole (bolt hole) 17 for a connection to a mating conductor. The mating conductor indicates a terminal for an electrical connection to the battery B and the electric equipment M which are connected to the wiring member 1 in the example illustrated in FIG. 1.

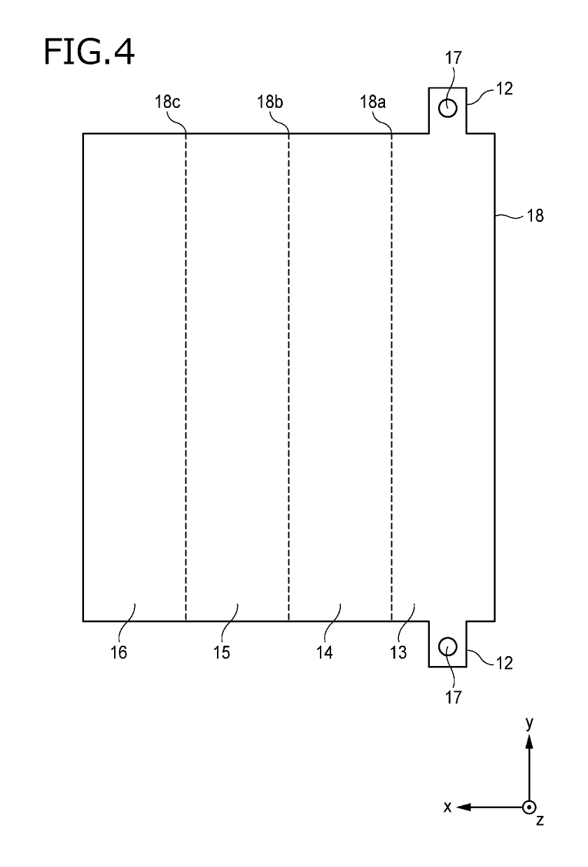

The conductive portion 11 having the layer-stacked structure of four layers is formed by a metal plate member 18 which extends in the longitudinal direction illustrated in FIG. 4. The metal plate member 18 is formed by punching out one sheet of metal plate. Specifically, the metal plate member 18 is first folded and overlapped along a vertical folding line 18a extending in the longitudinal direction, next folded and overlapped along a vertical folding line 18b extending in the longitudinal direction, and finally folded and overlapped along a vertical folding line 18c extending in the longitudinal direction, so that the conductive portion 11 having the layer-stacked structure of four layers is formed.

In the example illustrated in FIG. 4, the pair of connection portions 12 (including the through hole 17) is included in parts of the metal plate member 18 (specifically, in portions on the outside in the longitudinal direction of both ends of the first layer 13 in the longitudinal direction). Therefore, when the metal plate member 18 is folded and overlapped to complete the conductive portion 11, it is possible to obtain the conduction path 10 in which the conductive portion 11 and the pair of connection portions 12 are integrated. In a case where the pair of connection portions 12 is not included in the metal plate member 18, the pair of connection portions 12 may be provided at both ends of the conductive portion 11 in the longitudinal direction by welding after the metal plate member 18 is folded and overlapped to complete the conductive portion 11.

As illustrated in FIG. 2, an insulator (insulating coat) 19 is individually provided in each conduction path 10 such that the entire outer periphery of the conductive portion 11 having the layer-stacked structure of four layers is covered over the entire region in the longitudinal direction. The insulator 19 may be provided by, for example, extrusion molding or lamination molding.

In this way, the plurality (four in this example) of conduction paths 10 individually provided with the insulator 19 are disposed in parallel in the width direction to make the insulators 19 covering the adjacent conductive portions 11 come into contact with each other, so that the wiring member 1 is obtained. Therefore, in the wiring member 1, the insulator 19 is interposed between the adjacent conductive portions 11. The insulators 19 respectively covering the adjacent conductive portions 11 are bonded using an adhesive, or the like. With this configuration, it is possible to obtain the wiring member 1 in which the plurality (four in this example) of conduction paths 10 are integrated.

Hitherto, according to the wiring member 1 of the embodiment of the invention, each conductive portion 11 has the layer-stacked structure in which the metal plate member 18 is folded and overlapped. Therefore, each conductive portion 11 is increased in rigidity with respect to both the width direction and the height direction. For this reason, the wiring member 1 obtained by disposing the conductive portions 11 in parallel in the width direction is suitably used under a situation where rigidity in both the width and height directions is required. Since a cross-sectional area in a direction perpendicular to the longitudinal direction is not changed compared to that before the metal plate member 18 is folded and overlapped, a current capacity can also be kept.

In the wiring member 1, the positions in the height direction of the plurality of connection portions 12 are all the same. Therefore, flexibility in space is improved in a case where the plurality of connection portions 12 are connected to a plurality of mating conductors in a one-to-one manner compared to a case where the positions in the height direction in the plurality of connection portions 12 are different.

Further, in the wiring member 1, the completed conduction paths 10 are disposed in parallel in the width direction after the conduction paths 10 are individually completed by covering the outer periphery of the conductive portion 11 with the insulator 19, so that the wiring member 1 can be completed. Therefore, the wiring member 1 is manufactured with ease.

### Other Examples

The invention is not limited to the above embodiments, and various modifications can be employed within the scope of the invention. For example, the invention is not limited to the above embodiments, and modifications and improvements can be appropriately made. Besides, materials, shapes, dimensions, numbers, and layout places of the respective components in the above embodiments are arbitrary and not limited as long as the invention can be achieved.

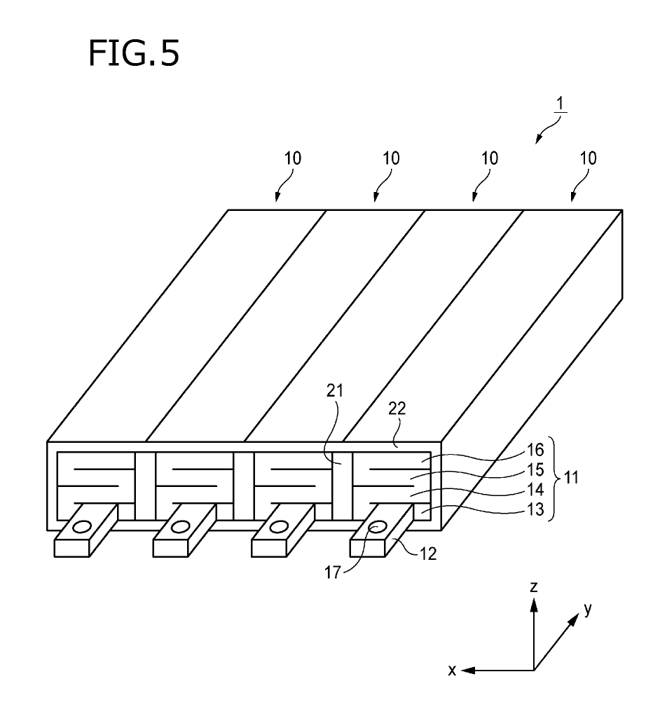

For example, in the embodiment, the insulators (insulating coats) 19 are individually provided in the respective conduction paths 10 such that the entire outer periphery of the conductive portion 11 is covered over the entire region in the longitudinal direction (see FIG. 2). With this regard, as illustrated in FIG. 5, a first insulator 21 interposed between the adjacent conductive portions 11 and a second insulator (insulating coat) 22 collectively covering the entire outer periphery of the plurality (four in this example) of conduction paths 10 over the entire region in the longitudinal direction may be individually provided. In this case, the insulating materials of the first and second insulators 21 and 22 may be the same or different.

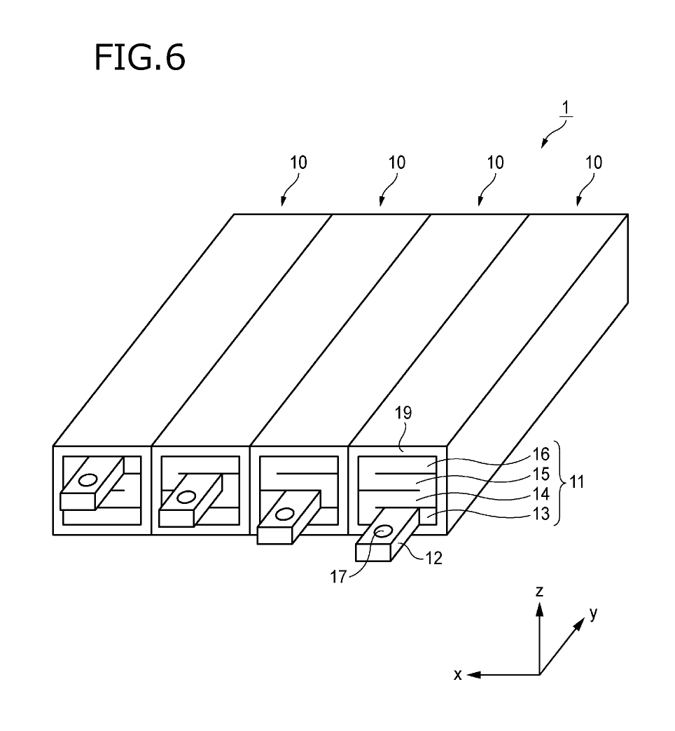

In the embodiment illustrated in FIG. 2, since all the conduction paths 10 are configured such that the respective connection portions 12 protrude from the first layers 13 of the conductive portions 11, the positions of the respective connection portions 12 in the height direction are all the same. With this regard, as illustrated in FIG. 6, the layer of the conductive portion 11 from where the connection portion 12 protrudes is different at every conduction path 10. Therefore, the positions of the respective connection portions 12 in the height direction may be different at every conduction path 10. In order to change a layer of the conductive portion 11 from which the connection portion 12 protrudes, the metal plate member 18 illustrated in FIG. 4 may be made different such that the position from where the connection portion 12 protrudes in the width direction (that is, a layer to which the position belongs) becomes different.

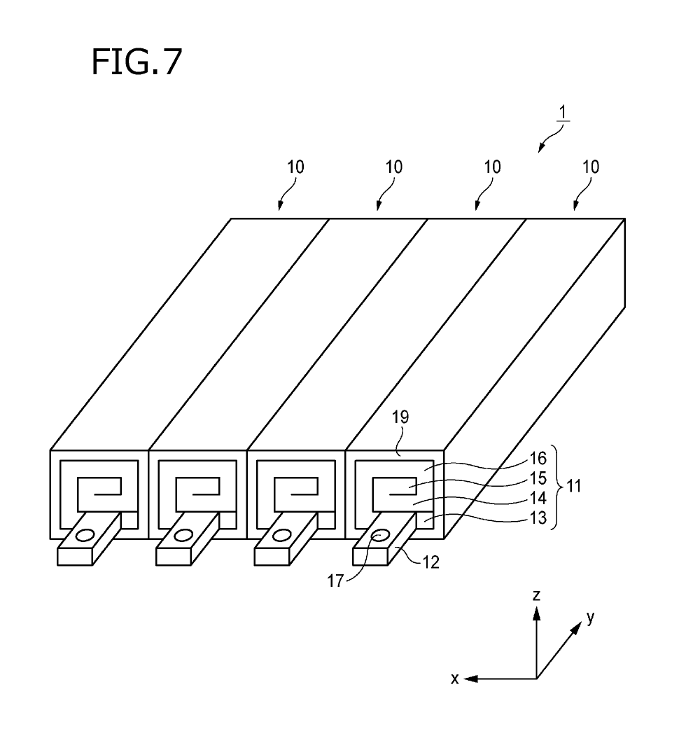

In the embodiment, when the metal plate member 18 is folded and overlapped multiple times to form the conductive portion 11 having the layer-stacked structure, a place folded and overlapped in a direction (a place folded and overlapped in a clockwise direction when viewed from the longitudinal direction) and a place folded and overlapped in the other direction opposite to the above direction (a place folded and overlapped in a counterclockwise direction when viewed from the longitudinal direction) are positioned alternately in the metal plate member 18 (see FIG. 2). With this regard, as illustrated in FIG. 7, the conductive portion 11 having the layer-stacked structure may be formed such that the metal plate member 18 is folded and overlapped multiple times only in one direction (a clockwise direction when viewed from the longitudinal direction).

As illustrated in FIG. 2, in the embodiment, the plurality of conduction paths 10 are disposed in parallel in the width direction in order to match a stacking direction in each conductive portion 11 having the layer-stacked structure to the height direction. With this regard, the plurality of conduction paths 10 may be disposed in parallel in the width direction in order to match the stacking direction in each conductive portion 11 having the layer-stacked structure to the width direction.

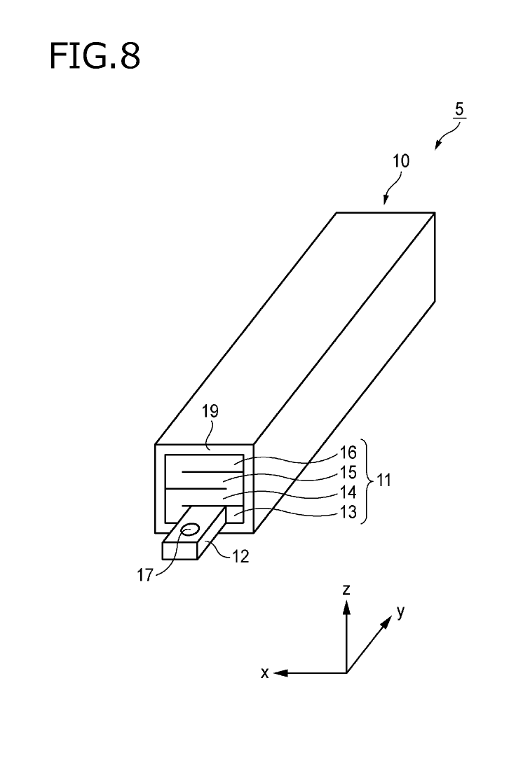

In the embodiment, the plurality of conductive portions 11 are disposed in parallel in any direction, and a wiring member 5 may be obtained using only one conductive portion 11 as illustrated as a third modification in FIG. 8.

In the embodiment, the connection portion 12 is provided at both ends of the conductive portion 11 in the longitudinal direction, and the connection portion 12 may be provided only in one of both ends of the conductive portion 11 in the longitudinal direction. In the embodiment, the conductive portion 11 has the layer-stacked structure of four layers (three vertical folding lines), but the conductive portion may have a layer-stacked structure of two layers (one vertical folding line), a layer-stacked structure of three layers (two vertical folding lines), or a layer-stacked structure of five or more layers (four or more vertical folding lines).

Herein, the features of the embodiments of the wiring member and the method of manufacturing the wiring member according to the invention will be simply summarized in the following [1] to [5].

[1] A wiring member (5) including:

a conduction path (10) including:
a conductive portion (11) which extends in a longitudinal direction of the conduction path (10); and
a connection portion (12) which is provided on at least one end of the conductive portion (11) in the longitudinal direction and is configured to be connected to a mating conductor,

wherein the conductive portion (11) has a layer-stacked structure in which a conductive plate member (18) is folded and overlapped at least one time along a vertical folding line extending in the longitudinal direction.

[2] A wiring member (1) including:

a plurality of conduction paths (10) each including:
a conductive portion (11) which extends in a longitudinal direction of each of the plurality of conduction paths; and
a connection portion (12) which is provided on at least one end of the conductive portion (11) in the longitudinal direction and is configured to be connected to a mating conductor,

wherein the plurality of conduction paths are disposed in parallel to each other in a width direction of each of the plurality of conduction paths perpendicular to the longitudinal direction so that an insulator (19, 21, 22) is arranged between adjacent conductive portions (11) of the plurality of conduction paths; and

wherein the conductive portion (11) of the each of the plurality of conduction paths has a layer-stacked structure in which a conductive plate member (18) is folded and overlapped at least one time along a vertical folding line (18a, 18b, 18c) extending in the longitudinal direction.

[3] The wiring member (1) according to [2], wherein the connection portions (12) of the plurality of conduction paths have the same positions in a height direction which is perpendicular to both of the longitudinal direction and the width direction.
[4] The wiring member (1) according to [2] or [3], wherein each of insulators (19) which are the same in number as the conductive portions (11) of the plurality of conduction paths covers an outer periphery of corresponding one of the conductive portions (11); and

wherein the plurality of conduction paths (10) are disposed in parallel in the width direction so that the insulators (19) respectively covering the adjacent conductive portions (11) come into contact with each other.

[5] A method of manufacturing a wiring member (1) which includes a plurality of conduction paths (10) each including a conductive portion (11) extending in a longitudinal direction of each of the plurality of conduction paths and a connection portion (12) provided on at least one end of the conductive portion (11) in the longitudinal direction and is configured to be connected to a mating conductor, the plurality of conduction paths being disposed in parallel to each other in a width direction of each of the plurality of conduction paths perpendicular to the longitudinal direction so that an insulator (19, 21, 22) is arranged between adjacent conductive portions (11) of the plurality of conduction paths, the method including:

folding and overlapping a conductive plate member (18) at least one time along a vertical folding line (18a, 18b, 18c) extending in the longitudinal direction to form one of the conduction paths (10) having the conductive portion (11) of a layer-stacked structure and the connection portion (12) which are integrally and continuously formed to each other; and

disposing the plurality of formed conduction paths (10) in parallel in the width direction so that the insulator (19, 21, 22) is arranged between adjacent conductive portions (11) of the plurality of conduction paths.

[6] The method according to [5], wherein the conductive plate member (18) is a singular conductive sheet.

What is claimed is:

1. A wiring member comprising:
a conduction path including:
a conductive portion which extends in a longitudinal direction of the conduction path: and
a connection portion which is provided on at least one end of the conductive portion in the longitudinal direction and is configured to be connected to a mating conductor,
wherein the conductive portion has a layer-stacked structure in which a conductive plate member is folded and overlapped at least one time along a vertical folding line extending in the longitudinal direction.

2. A wiring member comprising:
a plurality of conduction paths each including:
a conductive portion which extends in a longitudinal direction of each of the plurality of conduction paths; and
a connection portion which is provided on at least one end of the conductive portion in the longitudinal direction and is configured to be connected to a mating conductor,
wherein the plurality of conduction paths are disposed in parallel to each other in a width direction of each of the plurality of conduction paths perpendicular to the longitudinal direction so that an insulator is arranged between adjacent conductive portions of the plurality of conduction paths; and
wherein the conductive portion of the each of the plurality of conduction paths has a layer-stacked structure in which a conductive plate member is folded and overlapped at least one time along a vertical folding line extending in the longitudinal direction.

3. The wiring member according to claim 2, wherein the connection portions of the plurality of conduction paths have the same positions in a height direction which is perpendicular to both of the longitudinal direction and the width direction.

4. The wiring member according to claim 2, wherein each of insulators which are the same in number as the conductive portions of the plurality of conduction paths covers an outer periphery of corresponding one of the conductive portions; and
wherein the plurality of conduction paths are disposed in parallel in the width direction so that the insulators respectively covering the adjacent conductive portions come into contact with each other.

5. A method of manufacturing a wiring member which comprises a plurality of conduction paths each including a conductive portion extending in a longitudinal direction of each of the plurality of conduction paths and a connection portion provided on at least one end of the conductive portion in the longitudinal direction and is configured to be connected to a mating conductor, the plurality of conduction paths being disposed in parallel to each other in a width direction of each of the plurality of conduction paths perpendicular to the longitudinal direction so that an insulator is arranged between adjacent conductive portions of the plurality of conduction paths, the method comprising:
folding and overlapping a conductive plate member at least one time along a vertical folding line extending in the longitudinal direction to form one of the conduction paths having the conductive portion of a layer-stacked structure and the connection portion which are integrally and continuously formed to each other; and
disposing the plurality of formed conduction paths in parallel in the width direction so that the insulator is arranged between adjacent conductive portions of the plurality of conduction paths.

6. The method according to claim 5, wherein the conductive plate member is a singular conductive sheet.
